(19) United States
(12) Patent Application Publication
(10) Pub. No.: US 2026/0149172 A1
(43) Pub. Date: May 28, 2026

(54) METHOD FOR SATELLITE SEARCHING AND TRACKING IN A PHASED ARRAY ANTENNA

(71) Applicant: KNS INC., Daejeon (KR)

(72) Inventors: Byeong Wook JIN, Daejeon (KR); Gil Sang RYU, Daejeon (KR); Young Sun KIM, Daejeon (KR)

(21) Appl. No.: 19/199,986

(22) Filed: May 6, 2025

(30) Foreign Application Priority Data
Nov. 22, 2024 (KR) 10-2024-0169011

(51) Int. Cl. H01Q 3/24; H01Q 3/10; H01Q 3/34

(52) U.S. Cl. CPC H01Q 3/24; H01Q 3/10; H01Q 3/34

(57) ABSTRACT

A method for satellite searching and tracking in a phased array antenna may include: an initial configuration step of determining a theoretical azimuth and theoretical elevation for the phased array antenna; an attitude setting step of determining an azimuth adjustment and elevation adjustment based on the theoretical azimuth and theoretical elevation; a compensation determining step of determining an azimuth compensation and elevation compensation if one or more of the azimuth adjustment and elevation adjustment lies beyond an electronic scanning range of the phased array antenna; a compensation adjustment step in which an angle control platform adjusts the azimuth and elevation of the phased array antenna by the azimuth compensation and elevation compensation; and a tracking step of maintaining communication by performing a conical scan with the phased array antenna and continuously tracking a satellite.

### CROSS-REFERENCE TO RELATED APPLICATIONS

This application claims the benefit of Korean Patent Application No. 10-2024-0169011, filed with the Korean Intellectual Property Office on Nov. 22, 2024, the disclosure of which is incorporated herein by reference in its entirety.

### BACKGROUND

### 1. Technical Field

The present invention relates to a method for satellite searching and tracking in a phased array antenna, more particularly to method for satellite searching and tracking that incorporates electronic scanning and altitude and azimuth angle correction techniques.

### 2. Description of the Related Art

A low earth orbit (LEO) communication system is anticipated to play a vital role in future global communications due to its low transmission delay, low power consumption, and other advantages. However, low earth orbit satellite communication entails technical difficulties in searching and tracking the satellite from the ground due to the fast movement speed of the satellite in orbit.

The existing satellite communication system typically uses a narrow-beam reflector antenna installed on a mechanically stabilized platform to align the antenna beam with the satellite in real time by way of a platform and servo system. However, as this system uses a mechanical rotary mechanism, it entails the problems of low reaction speed, high control complexity, and limited tracking accuracy.

While a phased array antenna can quickly change the beam direction through the use of electronic scanning and thus provides a high reaction speed, the performance of the antenna is degraded when the scanning angle is expanded beyond ±60°. As such, the actual angle range in which a phased array antenna can be utilized is generally considered to be about ±60° (120°).

Due to this limit in the possible range of electronic scanning, it is difficult to apply the phased array antenna for satellite tracking in all directions or for effectively searching and tracking a low earth orbit satellite across all azimuth angles.

### SUMMARY OF THE INVENTION

An aspect of the present invention is to combine the phased array antenna with an angle control platform to provide a quick and stable method for the searching and real-time tracking of a satellite in low earth orbit satellite communication.

Another aspect of the invention is to overcome the limit in electronic scanning angles of the phased array antenna and thus enable satellite searching in a stable manner in all directions as well as to maintain optimal antenna performance by performing mechanical correction with an angle control platform.

Yet another aspect of the invention is to readjust the precision direction based on the direction in which a signal is detected during searching and ultimately maintain a connection by tracking the movement of a satellite in real time by using a conical scan.

Other objectives of the present invention will be more clearly understood from the embodiments set forth below.

One aspect of the invention provides a method for satellite searching and tracking in a phased array antenna, where the method includes: an initial configuration step of determining a theoretical azimuth and a theoretical elevation for the phased array antenna based on the orbit information of a satellite, the position information of a mobile node, and the attitude information of the mobile node; an attitude setting step of determining an azimuth adjustment and an elevation adjustment based on the theoretical azimuth and the theoretical elevation; a compensation determining step of determining an azimuth compensation and an elevation compensation if one or more of the azimuth adjustment and the elevation adjustment lies beyond an electronic scanning range of the phased array antenna; a compensation adjustment step in which an angle control platform adjusts the azimuth and elevation of the phased array antenna by the azimuth compensation and elevation compensation; and a tracking step of maintaining communication by performing a conical scan with the phased array antenna and continuously tracking a satellite.

Here, the method for satellite searching and tracking in a phased array antenna can further include: a searching step of performing a rectangular search by adjusting an azimuth and an elevation of the angle control platform to change a direction in which the phased array antenna is facing if a level value of a satellite signal received at the phased array antenna is smaller than a predetermined first value; and a precision adjustment step in which the angle control platform adjusts the azimuth and elevation of the phased array antenna such that the level value of the satellite signal at the phased array antenna becomes higher than the predetermined first value.

Here, the rectangular search can include drawing an angular spiral shape with a search trajectory of the phased array antenna.

Here, the azimuth compensation can be determined by Equation 1 shown below, and the elevation compensation can be determined by Equation 2 shown below:

$$A = \vert {A}_{1} - {A}_{2} \vert - q + {A}_{max} , \qquad [ Equation 1 ]$$

where A represents the azimuth compensation, A₁ represents the theoretical azimuth, A₂ represents a current azimuth, q represents a maximum azimuth of the electronic scanning range, and Aₘₐₓ represents a preset maximum azimuth angle for the rectangular search,

$$E = \vert {E}_{1} - {E}_{2} \vert - p + {E}_{max} , \qquad [ Equation 2 ]$$

where E represents the elevation compensation, E₁ represents the theoretical elevation, E₂ represents a current elevation, p represents a maximum elevation of the electronic scanning range, and Eₘₐₓ represents a preset maximum elevation angle for the rectangular search.

Here, the rectangular search can include searching with a beam of the phased array antenna by starting from the azimuth adjustment and the elevation adjustment and alternatingly moving the azimuth and elevation of the phased array antenna along a rectangular spiral, the rectangular spiral can be incremented in a stepwise manner by a first step angle for an increase in azimuth search range, and the rectangular spiral can be incremented in a stepwise manner by a second step angle for an increase in elevation search range.

Here, the first step angle can be determined by Equation 3 shown below, and the second step angle can be determined by Equation 4 shown below:

$${A}_{stop} = i \times w \times 0.5 , \qquad [ Equation 3 ]$$

where Aₛₜₑₚ represents the first step angle, w represents a beam width of the phased array antenna, and i represents a predetermined azimuth parameter,

$${E}_{stop} = j \times w \times 0.5 , \qquad [ Equation 4 ]$$

where Eₛₜₑₚ represents the second step angle, w represents the beam width of the phased array antenna, and j represents a predetermined elevation parameter.

Here, the orbit information of the satellite can be orbit information generated by using a HPOP model.

Here, the attitude setting step can further include: generating position coordinates (x₁, y₁, z₁) of the satellite with respect to earth from the orbit information of the satellite; and generating position coordinates (x₂, y₂, z₂) of the phased array antenna with respect to the earth after obtaining a latitude, longitude, and altitude of the phased array antenna.

Here, the theoretical azimuth can be determined by Equation 5 shown below, and the theoretical elevation can be determined by Equation 6 shown below:

$${A}_{1} = arctan \frac{( {y}_{1} - {y}_{2} )}{( {z}_{1} - {z}_{2} )} , \qquad [ Equation 5 ]$$

$${E}_{1} = arctan \frac{( {x}_{1} - {x}_{2} )}{\sqrt{{{( {z}_{1} - {z}_{2} )}^{2} + ( {y}_{1} - {y}_{2} ) )}^{2}}} . \qquad [ Equation 6 ]$$

Here, the variable i in Equation 3 can have a value greater than or equal to 0.2 and smaller than or equal to 0.8, and the variable j in Equation 4 can have a value greater than or equal to 0.2 and smaller than or equal to 0.8.

An embodiment of the invention can combine the phased array antenna with an angle control platform to provide a quick and stable method for the searching and real-time tracking of a satellite in low earth orbit satellite communication.

Also, an embodiment of the invention can overcome the limit in electronic scanning angles of the phased array antenna and can thus enable satellite searching in a stable manner in all directions while performing mechanical correction with an angle control platform to maintain optimal antenna performance.

Also, an embodiment of the invention can readjust the precision direction based on the direction in which a signal is detected during searching and can ultimately maintain a connection by tracking the movement of a satellite in real time by using a conical scan.

### BRIEF DESCRIPTION OF THE DRAWINGS

FIG. 1 is a flowchart of a method for satellite searching and tracking in a phased array antenna according to an embodiment of the invention.

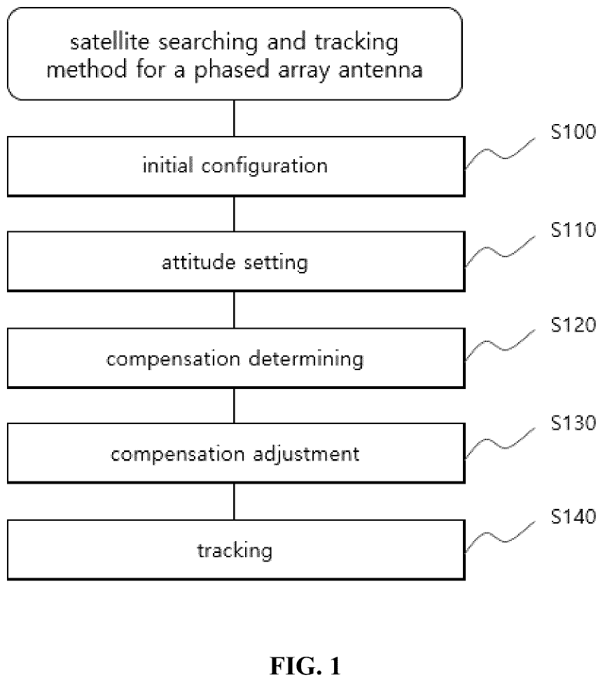

FIG. 2 is a diagram illustrating a rectangular search in the searching step according to an embodiment of the invention.

FIG. 3 is a perspective view conceptually illustrating a phased array antenna according to an embodiment of the invention.

FIG. 4 is a flowchart of a method for satellite searching and tracking in a phased array antenna according to another embodiment of the invention.

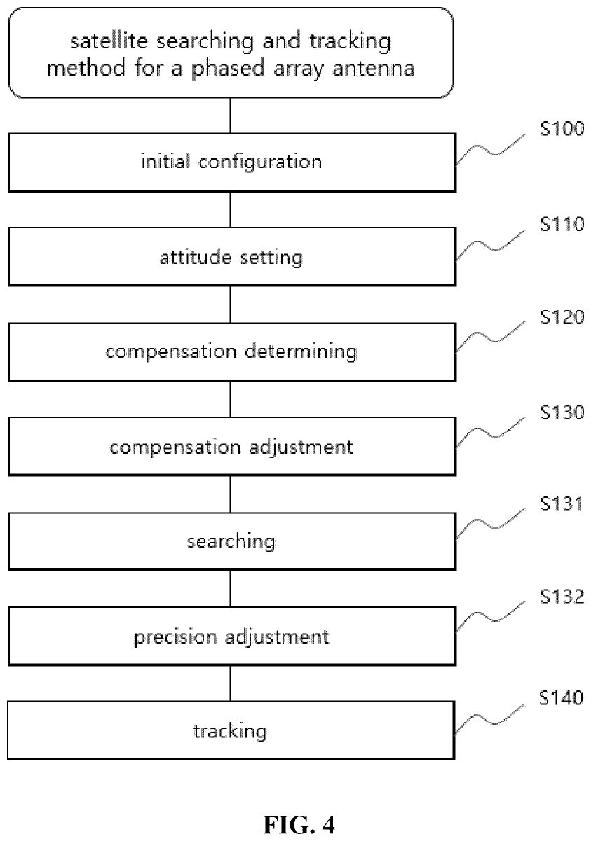

### DETAILED DESCRIPTION OF THE INVENTION

As the invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed by the present invention. In the description of the present invention, certain detailed explanations of the related art are omitted if it is deemed that they may unnecessarily obscure the essence of the invention.

While terms such as “first” and “second,” etc., can be used to describe various components, such components are not to be limited by the above terms. The above terms are used only to distinguish one component from another.

The terms used in the present specification are merely used to describe particular embodiments and are not intended to limit the present invention. An expression used in the singular encompasses the expression of the plural, unless it has a clearly different meaning in the context. In the present specification, it is to be understood that terms such as “including” or “having,” etc., are intended to indicate the existence of the features, numbers, steps, actions, components, parts, or combinations thereof disclosed in the specification and are not intended to preclude the possibility that one or more other features, numbers, steps, actions, components, parts, or combinations thereof may exist or may be added. Certain embodiments of the present invention will be described below in more detail with reference to the accompanying drawings.

Also, terms such as “about”, “substantially”, etc., used in the specification are intended to represent closeness to the succeeding numerical value when a manufacturing tolerance or content-related allowable range is provided. The terms are used to prevent the occurrence of the unscrupulous infringer unjustly using the disclosed invention if the specification were to describe the invention using exact or absolute numerals to aid the understanding of the invention.

The invention is described below in further detail using certain embodiments. It should be appreciated, however, that these embodiments are presented merely to aid the understanding of the invention and that the scope of protection is not limited by these embodiments.

Before a detailed description of the invention, a description is first provided of the terms used herein relating to axes and directions.

The azimuth refers to the angle between a perpendicular projection onto a reference plane of a vector from the observation point to the target and a reference vector present on the reference plane. In particular, in the case of a satellite antenna system, the observation point would be the satellite antenna, the target would be the direction in which the satellite antenna is facing, and the reference plane would be the ground plane. The reference vector points north. The “north” pointed by the reference vector can be selected from any one of true north, grid north, and magnetic north.

The elevation refers to the angle by which the satellite antenna faces up from the ground plane. An elevation of 0° can represent a direction parallel to the ground plane, while an elevation of 90° can represent the zenith, which is perpendicular to the ground plane.

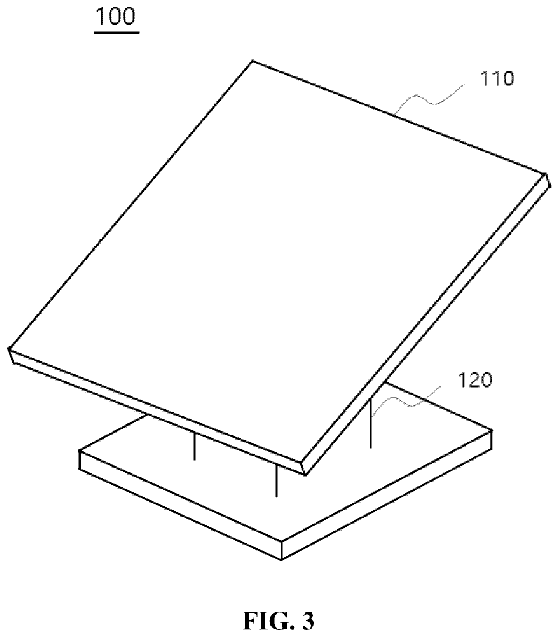

A phased array antenna according to an embodiment of the invention is conceptually illustrated in FIG. 3. A phased array antenna 100 according to an embodiment of the invention can include an antenna unit 110 and an angle control platform 120.

The antenna unit 110 can include multiple T/R components and multiple antenna components. A T/R component can include a semiconductor and can serve to generate a signal or process a received signal. The antenna component can be positioned on the surface and can directly receive a wave and transfer it to the T/R component or transmit a signal generated by the T/R component.

The conventional phased array antenna is placed parallel to the floor surface and hence, while capable of responding in all azimuth angles, faces difficulties in emitting or receiving waves for a low elevation angle of 30 degrees or lower.

Thus, a phased array antenna according to an embodiment of the invention may further include an angle control platform 120. The angle control platform 120 is for adjusting the azimuth and elevation of the phased array antenna and can have a shape and structure similar to those of a pedestal in a conventional parabolic antenna system.

The satellite searching and tracking method for a phased array antenna according to an embodiment of the invention can include an initial configuration step S100, an attitude setting step S110, a compensation determining step S120, a compensation adjustment step S130, and a tracking step S140.

The initial configuration step S100 can be a step for determining the theoretical azimuth and the theoretical elevation for the phased array antenna from the orbit information of the satellite, the position information of the mobile node, and the attitude information of the mobile node.

Here, the theoretical azimuth and the theoretical elevation can be the azimuth and elevation angles from the mobile node to the satellite when the ground plane is the reference plane.

The attitude setting step S110 can be a step for determining an azimuth adjustment and an elevation adjustment based on the theoretical azimuth and theoretical elevation determined above.

Here, the azimuth adjustment can be calculated as the difference between the azimuth that the phased array antenna is currently facing and the theoretical azimuth for the target satellite. For example, if the azimuth in which the phased array antenna is currently facing is 135° and the azimuth of the target satellite is 120°, then the azimuth adjustment can be −15°.

Similarly, the elevation adjustment can be calculated as the difference between the elevation that the phased array antenna is currently facing and the theoretical elevation for the target satellite.

The compensation determining step S120 can further include a step of determining whether or not one or more of the azimuth adjustment and the elevation adjustment is beyond the electronic scanning range of the phased array antenna. Here, the electronic scanning range can be the range in which the phased array antenna is able to emit a beam.

The phased array antenna can change the transmission direction of the beam within a certain range without the involvement of any mechanical movement. In the case of a high-performance phased array antenna equipped with many T/R components, the range in which the transmission direction of the beam can be changed is known to be as much as 120°. However, in order to communicate with a satellite that lies beyond this range, it is necessary for the phased array antenna to adjust the azimuth and elevation angles to face the satellite.

In short, the compensation determining step S120 can determine whether or not communication with the satellite is possible through a change in beam directionality only without changing the current attitude of the phased array antenna.

If it is determined that one or more of the azimuth adjustment and the elevation adjustment lies beyond the electronic scanning range of the phased array antenna in the compensation determining step S120, then a step of determining the azimuth compensation and elevation compensation can further be included.

Here, the azimuth compensation and the elevation compensation can refer to the azimuth and elevation angles that the phased array antenna is predicted to move for facing the satellite.

In the compensation adjustment step S130, the azimuth and elevation of the phased array antenna can be adjusted by the azimuth compensation and elevation compensation, where the adjustments of the azimuth and elevation can be performed by an angle control platform. A known satellite antenna pedestal, for example, can be used for the angle control platform.

The tracking step S140 can be a step of performing a scan with the phased array antenna and tracking and communicating with the satellite. Here, the scan can be a conical scan. A conical scan involves emitting a pencil beam having a thin bean width such that the pencil beam continuously rotates around a target and continuously measuring the intensity of the reflected wave to pinpoint and track a moving target.

According to another embodiment of the invention, the satellite searching and tracking method can further include a searching step S131 and a precision adjustment step S132.

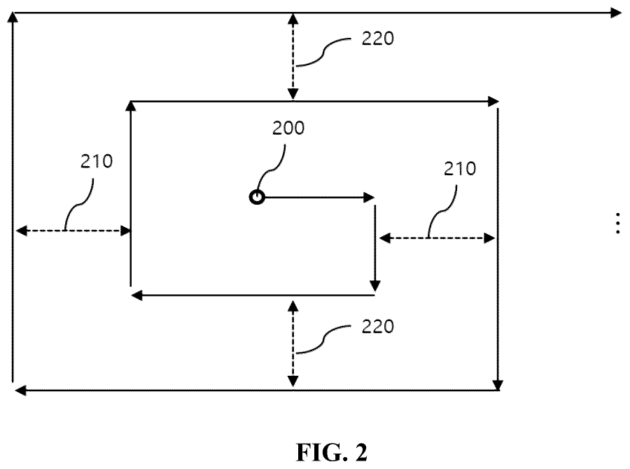

The searching step S131 can be performed by performing a rectangular search, as illustrated in FIG. 2, with the beam of the phased array antenna moved alternately along the azimuth and elevation directions such that the search trajectory of the beam follows a rectangular spiral centering around the point 200 corresponding to the azimuth and elevation that are adjusted based on the azimuth compensation and the elevation compensation.

Here, the rectangular spiral can be incremented in a stepwise manner by a first step angle 210 for an increase in azimuth search range and can be incremented in a stepwise manner by a second step angle 220 for an increase in elevation search range.

The first step angle can be determined by Equation 3 shown below.

$${A}_{stop} = i \times w \times 0.5 , \qquad [ Equation 3 ]$$

where Aₛₜₑₚ represents the first step angle,
w represents the beam width of the phased array antenna, and
i represents a predetermined azimuth parameter.

Also, the second step angle can be determined by Equation 4 shown below.

$${E}_{stop} = j \times w \times 0.5 , \qquad [ Equation 4 ]$$

where Eₛₜₑₚ represents the second step angle,
w represents the beam width of the phased array antenna, and
j represents a predetermined elevation parameter.

Here, the value of i in Equation 3 can be greater than or equal to 0.2 and smaller than or equal to 0.8. Preferably, the value of i in Equation 3 can be 0.5. If the value of i is smaller than 0.2, the rectangular spiral can become too dense along the azimuth direction, and areas of unnecessary overlap can increase, resulting in an increase in search time. If the value of i is greater than 0.8, the rectangular spiral can become too sparse along the azimuth direction, and there may be areas that are overlooked in the search, resulting an increased possibility of missing a satellite signal.

Similarly, the value of j in Equation 4 can be greater than or equal to 0.2 and smaller than or equal to 0.8. Preferably, the value of j in Equation 4 can be 0.5. If the value of j is smaller than 0.2, the rectangular spiral can become too dense along the elevation direction, and areas of unnecessary overlap can increase, resulting in an increase in search time. If the value of j is greater than 0.8, the rectangular spiral can become too sparse along the elevation direction, and there may be areas that are overlooked in the search, resulting an increased possibility of missing a satellite signal.

w can represent the beam width of the phased array antenna. The beam width of the phased array antenna can be, for example, greater than or equal to 3° and smaller than or equal to 10°. Preferably, the beam width of the phased array antenna can be 5°. However, the beam width is not limited thus, and various beam widths can be used according to the composition of the phase shift device and the components of the phased array antenna.

In the searching step S131, if an azimuth and elevation are found at which the level value of the satellite signal at the phased array antenna is higher than a predetermined first value, then the precision adjustment step S132 can be performed to realign the phased array antenna.

Here, the predetermined first value can be a signal level value with which a phased array antenna according to an embodiment of the invention can maintain normal communication with a low earth orbit satellite. For example, the predetermined first value can be one of −10 dBm, −20 dBm, −30 dBm, −40 dBm, −50 dBm, −60 dBm, or −70 dBm.

The precision adjustment step S132 can be a step in which the angle control platform adjusts the azimuth and elevation of the phased array antenna such that the level value of the satellite signal at the phased array antenna becomes higher than the predetermined first value.

In short, if the satellite signal received by the phased array antenna is still lower than the predetermined first value even after the direction of the phased array antenna has been adjusted in the searching step S131, then the precision adjustment step can entail having the phased array antenna face a direction with which the signal strength is actually made higher.

For this purpose, the searching step can include performing a rectangular search in which the direction faced by the phased array antenna is changed continuously based on adjustments to the azimuth and elevation of the angle control platform of the phased array antenna and thus continuously searching the vicinity of the theoretical azimuth and theoretical elevation.

According to another embodiment of the invention, the satellite searching and tracking method for a phased array antenna can include an initial configuration step S100, an attitude setting step S110, a compensation determining step S120, a compensation adjustment step S130, a searching step S131, a precision adjustment step S132, and a tracking step S140.

According to an embodiment of the invention, the rectangular search can entail drawing an angular spiral shape with the search trajectory of the phased array antenna. Here, the angular spiral shape can be a shape that moves alternatingly along the lateral and longitudinal directions to move further away from the center. The trajectory of the phased array antenna drawn in the air by the rectangular search drawing an angular spiral shape is illustrated in FIG. 2.

According to another embodiment of the invention, the azimuth compensation can be determined by Equation 1 shown below, and the elevation compensation can be determined by Equation 2 shown below.

$$A = \vert {A}_{1} - {A}_{2} \vert - q + {A}_{max} , \qquad [ Equation 1 ]$$

where A represents the azimuth compensation, A₁ represents the theoretical azimuth, A₂ represents the current azimuth, q represents the maximum azimuth of the electronic scanning range, and Aₘₐₓ represents the preset maximum azimuth angle for the rectangular search.

$$E = \vert {E}_{1} - {E}_{2} \vert - p + {E}_{max} , \qquad [ Equation 2 ]$$

where, E represents the elevation compensation, E₁ represents the theoretical elevation, E₂ represents the current elevation, p represents the maximum elevation of the electronic scanning range, and Eₘₐₓ represents the preset maximum elevation angle for the rectangular search.

That is, the azimuth compensation shown in Equation 1 above can be obtained by calculating the difference between the azimuth that the antenna should be facing (A₁; the theoretical azimuth) and the azimuth that the antenna is currently facing (A₂; the current azimuth), excluding the angle range of the azimuth that can be obtained by an electronic adjustment of the beam (q; the maximum azimuth of the electronic scanning range) so as to reduce the mechanical movement by an amount that can be achieved through an electronic adjustment, and adding a surplus of the azimuth for performing the rectangular search (Aₘₐₓ). Accordingly, the azimuth compensation of Equation 1 above can represent an amount of azimuth movement that can provide a minimal amount of space in which to perform the rectangular search while minimizing mechanical movement.

Similarly, the elevation compensation shown in Equation 2 above can be obtained by calculating the difference between the elevation that the antenna should be facing (E₁; the theoretical elevation) and the elevation that the antenna is currently facing (E₂; the current elevation), excluding the angle range of the elevation that can be obtained by an electronic adjustment of the beam (p; the maximum elevation of the electronic scanning range) so as to reduce the mechanical movement by an amount that can be achieved through an electronic adjustment, and adding a surplus of the elevation for performing the rectangular search (Eₘₐₓ). Accordingly, the elevation azimuth compensation of Equation 2 above can represent an amount of elevation movement that can provide a minimal amount of space in which to perform the rectangular search while minimizing mechanical movement.

Here, the electronic scanning can represent scanning by altering the direction of the beam through a phase adjustment of the phased array antenna rather than mechanically rotating the phased array antenna.

The HPOP (high-precision orbit propagator) model, which is used for high-precision predictions of the orbit of a satellite, is a technique that calculates the orbit based on an intricate consideration of various external factors such as, among others, the gravitational field of the earth, atmospheric resistance, the radiation pressure of the sun, and the gravitational forces of the moon and sun. The model allows a very accurate prediction of the orbit based on these factors and can play an important role in satellite positioning, collision avoidance, and mission planning.

A method of generating orbit information using the HPOP model can include an initial collecting of orbit factors such as the position and speed information of the satellite, applying an intricate gravity model that incorporates the non-spherical gravitational field of the earth and the gravitational fields of the sun and moon, making computations in consideration of factors other than gravity such as atmospheric resistance and solar radiation pressure, and making an integral calculation to obtain the position and speed of the satellite. This allows an accurate calculation of the position of the satellite as a function of time and can provide a much higher degree of precision in predicting the orbit compared to other simpler models.

The attitude setting step S110 can, more specifically, further include a step of generating the position coordinates (x₁, y₁, z₁) of the satellite at the current time with respect to the earth from the orbit information of the satellite.

Also, the attitude setting step S110 can, more specifically, further include a step of generating the position coordinates (x₂, y₂, z₂) of the phased array antenna with respect to the earth from the latitude, longitude, and altitude of the phased array antenna.

Once the position coordinates of the satellite and the position coordinates of the phased array antenna have been generated, the theoretical azimuth and the theoretical elevation can be specifically defined.

The theoretical azimuth can be determined by Equation 5 shown below.

$${A}_{1} = arctan \frac{( {y}_{1} - {y}_{2} )}{( {z}_{1} - {z}_{2} )} , \qquad [ Equation 5 ]$$

Also, the theoretical elevation can be determined by Equation 6 shown below.

$${E}_{1} = arctan \frac{( {x}_{1} - {x}_{2} )}{\sqrt{{{( {z}_{1} - {z}_{2} )}^{2} + ( {y}_{1} - {y}_{2} ) )}^{2}}} \qquad [ Equation 6 ]$$

As the predicted position of the satellite is determined by the HPOP model, the current position of the mobile node is determined by a GPS, and the theoretical azimuth and theoretical elevation are calculated from an accurate mathematical computation based on the predicted position of the satellite and the current position of the mobile node, the theoretical azimuth and theoretical elevation can be derived quickly and accurately.

A mobile node referred to herein can include a means of transportation for moving a person or an object. Also, a mobile node referred to herein can include any means of transportation that is not used for moving anything. For example, a mobile node can include a ship, a water leisure craft, an underwater mobile means, a plane, an automobile, a drone, a train, an autonomous tracked vehicle, a monorail, a tram, a bicycle, a skateboard, a satellite, a space shuttle, a planetary exploration rover, a hyperloop, a hoverboard, a personal aerial vehicle, an autonomous shuttle, and a personal mobile device.

The preferred embodiments of the present invention provided above are disclosed for illustrative purposes only. It should be appreciated that the skilled person having ordinary skill in regard to the present invention would be able to make various modifications, alterations, and additions without departing from the spirit and scope of the present invention and that such modifications, alterations, and additions are encompassed within the scope of claims below.

What is claimed is:

1. A method for satellite searching and tracking in a phased array antenna, the method comprising:
an initial configuration step of determining a theoretical azimuth and a theoretical elevation for the phased array antenna based on orbit information of a satellite, position information of a mobile node, and attitude information of the mobile node;
an attitude setting step of determining an azimuth adjustment and an elevation adjustment based on the theoretical azimuth and the theoretical elevation;
a compensation determining step of determining an azimuth compensation and an elevation compensation if one or more of the azimuth adjustment and the elevation adjustment lies beyond an electronic scanning range of the phased array antenna;
a compensation adjustment step of adjusting an azimuth and an elevation of the phased array antenna by the azimuth compensation and elevation compensation, the compensation adjustment step performed by an angle control platform; and
a tracking step of maintaining communication by performing a conical scan with the phased array antenna and continuously tracking a satellite.

2. The method for satellite searching and tracking in a phased array antenna according to claim 1, further comprising:
a searching step of performing a rectangular search by adjusting an azimuth and an elevation of the angle control platform to change a direction in which the phased array antenna is facing if a level value of a satellite signal received at the phased array antenna is smaller than a predetermined first value; and
a precision adjustment step of adjusting the azimuth and elevation of the phased array antenna such that the level value of the satellite signal at the phased array antenna becomes higher than the predetermined first value, the precision adjustment step performed by the angle control platform.

3. The method for satellite searching and tracking in a phased array antenna according to claim 2, wherein the rectangular search includes drawing an angular spiral shape with a search trajectory of the phased array antenna.

4. The method for satellite searching and tracking in a phased array antenna according to claim 3, wherein the azimuth compensation is determined by Equation 1 shown below, and
the elevation compensation is determined by Equation 2 shown below:
$$A = \vert {A}_{1} - {A}_{2} \vert - q + {A}_{max} , \qquad [ Equation 1 ]$$
where A represents the azimuth compensation, A₁ represents the theoretical azimuth, A₂ represents a current azimuth, q represents a maximum azimuth of the electronic scanning range, and Aₘₐₓ represents a preset maximum azimuth angle for the rectangular search,
$$E = \vert {E}_{1} - {E}_{2} \vert - p + {E}_{max} , \qquad [ Equation 2 ]$$
where E represents the elevation compensation, E₁ represents the theoretical elevation, E₂ represents a current elevation, p represents a maximum elevation of the electronic scanning range, and Eₘₐₓ represents a preset maximum elevation angle for the rectangular search.

5. The method for satellite searching and tracking in a phased array antenna according to claim 4, wherein the rectangular search comprises searching with a beam of the phased array antenna by starting from the azimuth adjustment and the elevation adjustment and alternatingly moving the azimuth and elevation of the phased array antenna along a rectangular spiral,
the rectangular spiral is incremented in a stepwise manner by a first step angle for an increase in azimuth search range, and
the rectangular spiral is incremented in a stepwise manner by a second step angle for an increase in elevation search range.

6. The method for satellite searching and tracking in a phased array antenna according to claim 5, wherein the first step angle is determined by Equation 3 shown below, and the second step angle is determined by Equation 4 shown below:
$${A}_{stop} = i \times w \times 0.5 , \qquad [ Equation 3 ]$$
where Aₛₜₑₚ represents the first step angle,
w represents a beam width of the phased array antenna, and
i represents a predetermined azimuth parameter,
$${E}_{stop} = j \times w \times 0.5 , \qquad [ Equation 4 ]$$
where Eₛₜₑₚ represents the second step angle,
w represents the beam width of the phased array antenna, and
j represents a predetermined elevation parameter.

7. The method for satellite searching and tracking in a phased array antenna according to claim 6, wherein the orbit information of the satellite comprises orbit information generated by using a HPOP model.

8. The method for satellite searching and tracking in a phased array antenna according to claim 7, wherein the attitude setting step further comprises:
generating position coordinates (x₁, y₁, z₁) of the satellite with respect to earth from the orbit information of the satellite; and
generating position coordinates (x₂, y₂, z₂) of the phased array antenna with respect to the earth after obtaining a latitude, longitude, and altitude of the phased array antenna.

9. The method for satellite searching and tracking in a phased array antenna according to claim 8, wherein the theoretical azimuth is determined by Equation 5 shown below, and the theoretical elevation is determined by Equation 6 shown below:
$${A}_{1} = arctan \frac{( {y}_{1} - {y}_{2} )}{( {z}_{1} - {z}_{2} )} , \qquad [ Equation 5 ]$$
$${E}_{1} = arctan \frac{( {x}_{1} - {x}_{2} )}{\sqrt{{{( {z}_{1} - {z}_{2} )}^{2} + ( {y}_{1} - {y}_{2} ) )}^{2}}} . \qquad [ Equation 6 ]$$

10. The method for satellite searching and tracking in a phased array antenna according to claim 9, wherein the variable i in Equation 3 has a value greater than or equal to 0.2 and smaller than or equal to 0.8, and
the variable j in Equation 4 has a value greater than or equal to 0.2 and smaller than or equal to 0.8.
